(19) United States
(12) Patent Application Publication
(10) Pub. No.: US 2012/0105955 A1
(43) Pub. Date: May 3, 2012

(54) OPTICAL DEVICE AND STEREOSCOPIC DISPLAY APPARATUS

(75) Inventor: Yuichi Takai, Tokyo (JP)

(73) Assignee: Sony Corporation, Tokyo (JP)

(21) Appl. No.: 13/281,658

(22) Filed: Oct. 26, 2011

(30) Foreign Application Priority Data
Nov. 2, 2010 (JP) 2010-246507

(51) Int. Cl. G02B 27/22; G02B 3/12; G02B 27/12

(52) U.S. Cl. 359/463; 359/619; 359/665

(57) ABSTRACT

An optical device includes first and second substrates disposed opposite each other; a partition wall provided upright on an inner surface of the first substrate, facing the second substrate, and extending, to divide a region on the first substrate into cell regions arranged in a first direction, in a second direction different from the first direction; first and second electrodes disposed on wall surfaces of the partition wall to face each other in each of the cell regions; an insulation film; a third electrode provided on an inner surface of the second substrate facing the first substrate; a protruding section formed upright on the inner surface of the second substrate and dividing each of the cell regions into sub cell regions arranged in the second direction; and polarity and non-polarity liquids sealed between the first substrate and the third electrode.

### CROSS REFERENCES TO RELATED APPLICATIONS

The present application claims priority to Japanese Patent Application No. 2010-246507 filed on Nov. 2, 2010, the disclosure of which is incorporated herein by reference.

### BACKGROUND

The present disclosure relates to an optical device using an electrowetting phenomenon, and a display apparatus including the same.

In the related art, a liquid optical device has been developed which achieves an optical operation using an electrowetting phenomenon (electrocapillary phenomenon). The electrowetting phenomenon refers to a phenomenon where if voltage is applied between an electrode and a conductive liquid, interface energy between a surface of the electrode and the liquid is changed to thereby change the surface shape of the liquid.

As the liquid optical device which uses the electrowetting phenomenon, for example, there have been proposed liquid cylindrical lenses as disclosed in JP-A-2002-162507 and JP-A-2009-251339. Further, in JP-T-2007-534013 and JP-A-2009-217259, liquid lenticular lenses are disclosed.

### SUMMARY

In the liquid lenses as disclosed in the above-mentioned JP-A-2002-162507, JP-A-2009-251339, JP-T-2007-534013 and JP-A-2009-217259, in general, interface shapes of two types of liquids which are separated from each other and have different refractive indexes are changed by controlling voltage applied to electrodes to obtain a desired focal distance. Further, the two types of liquids are approximately the same in specific gravity, so that deflection due to gravity does not easily occur even if the posture of the liquid lens is variously changed.

However, between the liquids having different components, discrepancy of the specific gravity occurs according to environmental temperature. That is, even though the specific gravities of two types of liquids are the same at an initial environmental temperature (for example, 20° C.), if the environmental temperature is changed, the specific gravities of the liquids may be changed according to the environmental temperature change. Thus, for example, in the cylindrical lenses disclosed in JP-A-2002-162507 and JP-A-2009-251339, two types of liquids filled in a predetermined cell region between a pair of opposite substrates may significantly deviate from an initial position. That is, when an axial direction of the cylindrical lens becomes a vertical direction in use, a liquid having a relatively small specific gravity may move upwards in the cell region and a liquid having a relatively large specific gravity may move downwards in the cell region, depending upon the length thereof. Then, although the interface of two types of liquids is initially parallel to the surfaces of the pair of opposite substrates in a state where voltage is not applied, the interface 130 may be inclined with respect to the surfaces of the pair of opposite substrates, as shown in FIG. 14. Here, the optical device shown in FIG. 14 includes a pair of planar substrates 121 and 122 which are disposed being opposite to each other, and side walls 123 which are provided upright along outer edges and support the planar substrates 121 and 122. A polarity liquid 128 and a non-polarity liquid 129 are sealed in a space closed by the planar substrates 121 and 122 and the side walls 123, to thereby form the interface 130. In this case, even though voltage applied to electrodes is changed, the electrowetting phenomenon may not occur, or it may be difficult to accurately control the shape of the interface. Thus, it is desirable to stably maintain an interface of two types of liquids having different refractive indexes over a long period of time.

Accordingly, it is desirable to provide an optical device which is capable of stably realizing the electrowetting phenomenon over a long period of time and of stably achieving an excellent optical operation, and a stereoscopic display apparatus including the same.

An optical device according to an embodiment of the present disclosure includes the following elements (A1) to (A7):

(A1) a first substrate and a second substrate which are disposed being opposite to each other;

(A2) a partition wall which is provided on an inner surface of the first substrate, which faces the second substrate, and extends, to divide a region on the first substrate into a plurality of cell regions which are arranged in a first direction, in a second direction which is different from the first direction;

(A3) a first electrode and a second electrode which are disposed on wall surfaces of the partition wall to face each other in each of the plurality of cell regions;

(A4) an insulation film which covers the first and second electrodes;

(A5) a third electrode which is provided on an inner surface of the second substrate which faces the first substrate;

(A6) a protruding section which is formed upright on the inner surface of the second substrate and divides each of the plurality of cell regions into a plurality of sub cell regions which are arranged in the second direction; and

(A7) a polarity liquid and a non-polarity liquid which are sealed between the first substrate and the third electrode and have different refractive indexes.

A stereoscopic display apparatus according to another embodiment of the present disclosure includes display means and the optical device according to the above-described embodiment. For example, the display means is a display which includes a plurality of pixels and generates a two dimensional display image corresponding to a video signal.

In the optical device and the stereoscopic display apparatus according to the embodiments of the present disclosure, the protruding section is formed upright on the second substrate so as to divide the cell region formed by the partition wall into the plurality of sub cell regions. With this configuration, even if the cell region is in a posture extending in a vertical direction, the two types of liquids having different refractive indexes and different specific gravities are stably retained in the peripheral members including the protruding section, the partition wall and the like, according to the capillary phenomenon. Further, as the partition wall which forms the plurality of cell regions is provided on the first substrate and the protruding section which divides each cell region into the plurality of sub cell regions is provided on the second substrate, it is possible to achieve a structure that is advantageous for accurate and efficient manufacturing. For example, as the first substrate on which the partition wall is formed has a uniform sectional shape in the second direction along which the partition wall extends, the first substrate may be formed by uniaxial molding such as extrusion molding or laminated transfer using a molding roll. Accordingly, it is possible to easily obtain a partition wall having a shape of high accuracy. Further, it is possible to easily form the first and second electrodes, compared with a case where the partition wall and the protruding section are provided together on the first substrate. Further, as the partition wall which is provided upright on the first substrate and the protruding section which is provided upright on the second substrate are coupled with each other when the optical device is assembled, it is possible to easily position the first substrate and the second substrate.

According to the optical device of the embodiment of the present disclosure, as the partition wall which divides the region on the first substrate into the plurality of cell regions is provided on the first substrate and the protruding section which further divides each cell region into the plurality of sub cell regions is provided on the second substrate, the following effects are obtained. That is, it is possible to stably maintain the interface of the two types of liquids contained therein over a long period of time, and to stably and accurately achieve a desired optical operation, without being influenced by the gravity due to its posture. Thus, according to the stereoscopic display apparatus of the embodiment, including such an optical device, it is possible to realize a correct image display corresponding to a predetermined video signal over a long period of time. Further, as the partition wall is provided on the first substrate and the protruding section is provided on the second substrate, it is possible to realize accurate and efficient manufacturing.

Additional features and advantages are described herein, and will be apparent from the following Detailed Description and the figures.

### BRIEF DESCRIPTION OF THE FIGURES

FIG. 1 is diagram schematically illustrating a configuration of a stereoscopic display apparatus according to an embodiment of the present disclosure;

FIG. 2 is a cross-sectional view illustrating a main configuration of a wavefront conversion deflecting section shown in FIG. 1;

FIGS. 3A and 3B are different cross-sectional views illustrating the main configuration of the wavefront conversion deflecting section shown in FIG. 1;

FIG. 4 is a cross-sectional view taken along line IV-IV of the wavefront conversion deflecting section shown in FIG. 2;

FIGS. 5A to 5C are conceptual diagrams illustrating an operation of a liquid optical device shown in FIGS. 3A and 3B;

FIGS. 6A and 6B are different conceptual diagrams illustrating the operation of the liquid optical device shown in FIGS. 3A and 3B;

FIG. 7 is a cross-sectional view schematically illustrating a process in a manufacturing method of the wavefront converting section shown in FIG. 1;

FIGS. 8A and 8B are cross-sectional views schematically illustrating a process subsequent to the process in FIG. 7;

FIG. 9 is a cross-sectional view schematically illustrating a process subsequent to the process in FIGS. 8A and 8B;

FIG. 10 is a cross-sectional view schematically illustrating a configuration of a wavefront conversion deflecting section according to a first modification;

FIG. 11 is a cross-sectional view schematically illustrating a configuration of a wavefront conversion deflecting section according to a second modification;

FIG. 12 is a cross-sectional view schematically illustrating a configuration of a wavefront conversion deflecting section according to a third modification;

FIG. 13 is a cross-sectional view illustrating a different application example of the wavefront conversion deflecting section shown in FIG. 1; and

FIG. 14 is a cross-sectional view illustrating a configuration example of a liquid optical device in the related art.

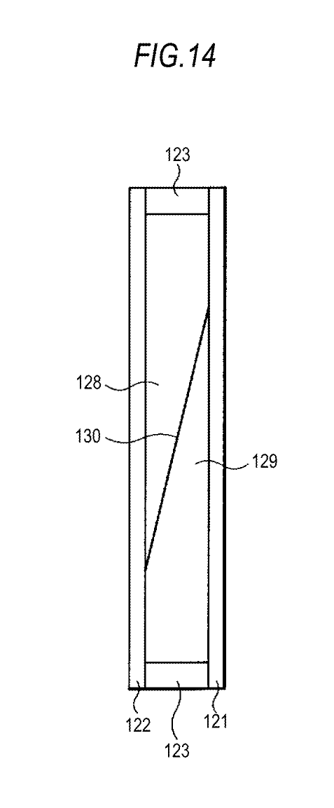

### DETAILED DESCRIPTION

Embodiments of the present application will be described below in detail with reference to the drawings.

### <Configuration of Stereoscopic Display Apparatus>

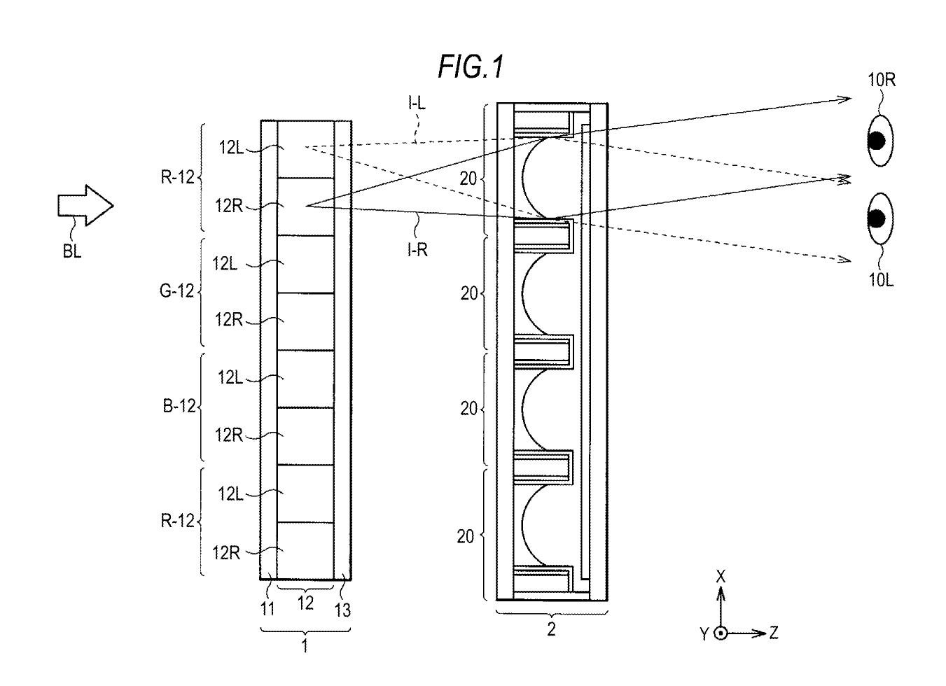

Firstly, a stereoscopic display apparatus which uses an optical device according to an embodiment will be described with reference to FIG. 1. FIG. 1 is a diagram schematically illustrating a configuration example, in a horizontal plane, of the stereoscopic display apparatus according to the present embodiment.

As shown in FIG. 1, the stereoscopic display apparatus includes a display section 1 which has a plurality of pixels 11, and a wavefront conversion deflecting section 2 which is an optical device, which are sequentially disposed when seen from the side of an optical source (not shown). Here, a traveling direction of light from the optical source is a Z axis direction; a horizontal direction is an X axis direction, and a vertical direction is a Y axis direction.

The display section 1 generates a two dimensional display image according to a video signal, and is a color liquid crystal display which emits display image light by emission of a backlight BL, for example. The display section 1 has a structure in which a glass substrate 11, a plurality of pixels 12 (12L and 12R) which include a pixel electrode and a liquid crystal layer, respectively, and a glass substrate 13 are sequentially layered when seen from the optical source side. The glass substrate 11 and the glass substrate 13 are transparent, and a color filter having a coloring layer of red (R), green (G) and blue (B) is provided to either the glass substrate 11 or the glass substrate 13. Thus, the pixels 12 are classified into a pixel R-12 which displays red, a pixel G-12 which displays green and a pixel B-12 which displays blue. In the display section 1, the pixels R-12, the pixels G-12, and the pixels B-12 are sequentially repeatedly disposed in the X axis direction, whereas the pixels 12 having the same colors are disposed in the Y axis direction. Further, the pixels 12 are classified into a pixel which emits display image light which forms a left eye image and a pixel which emits display image light which forms a right eye image, which are alternatively disposed in the X axis direction. In FIG. 1, the pixel 12 which emits the left eye display image light is represented as a pixel 12L, and the pixel 12 which emits the right eye display image light is represented as a pixel 12R.

The wavefront conversion deflecting section 2 is provided in an array shape in which a liquid optical device 20, which is formed corresponding to one set of pixels 12L and 12R which are adjacent to each other in the X axis direction, for example, is disposed along the X axis direction over a plurality of times. The wavefront conversion deflecting section 2 performs a wavefront conversion process and a deflecting process for the display image light emitted from the display section 1. Specifically, in the wavefront conversion deflecting section 2, each liquid optical device 20 corresponding to each pixel 12 functions as a cylindrical lens. That is, the wavefront conversion deflecting section 2 functions as a lenticular lens as a whole. Thus, wavefronts of the display image lights from the respective pixels 12L and 12R are all together converted into wavefronts having a predetermined curvature over a unit group of pixels 12 which is aligned in the vertical direction (Y axis direction). In the wavefront conversion deflecting section 2, it is possible to collectively deflect the display image lights in the horizontal plane (XZ plane) as necessary.

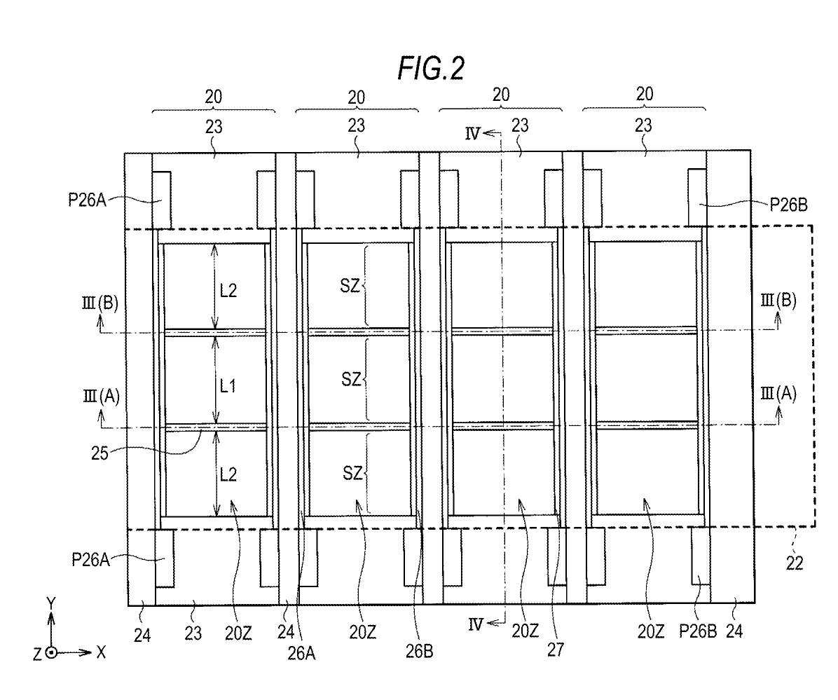

A specific configuration of the wavefront conversion deflecting section 2 will be described with reference to FIGS. 2 to 4.

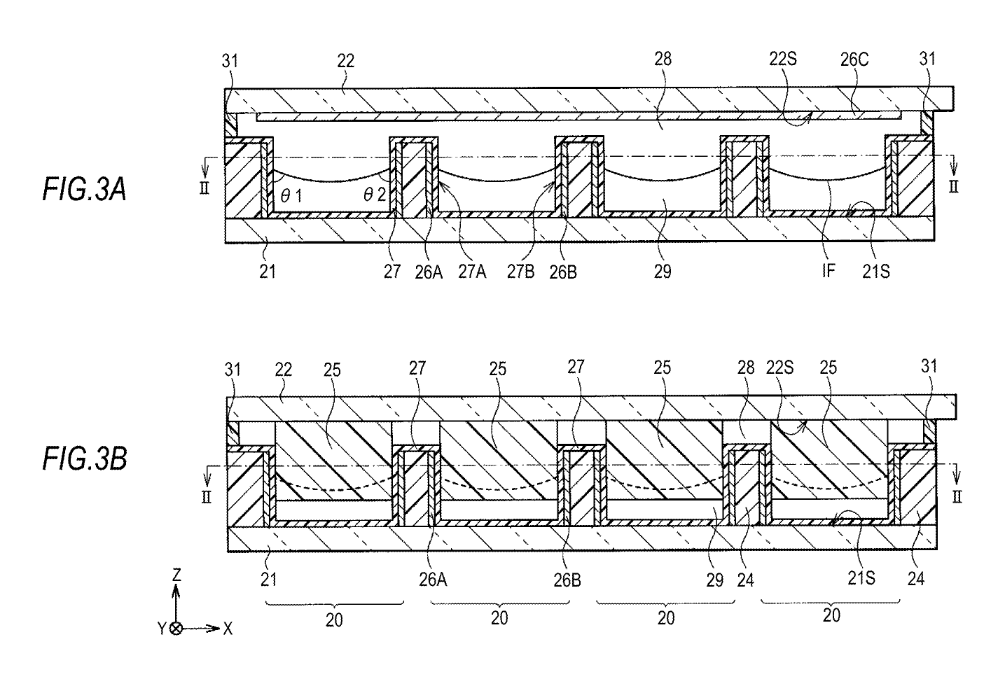

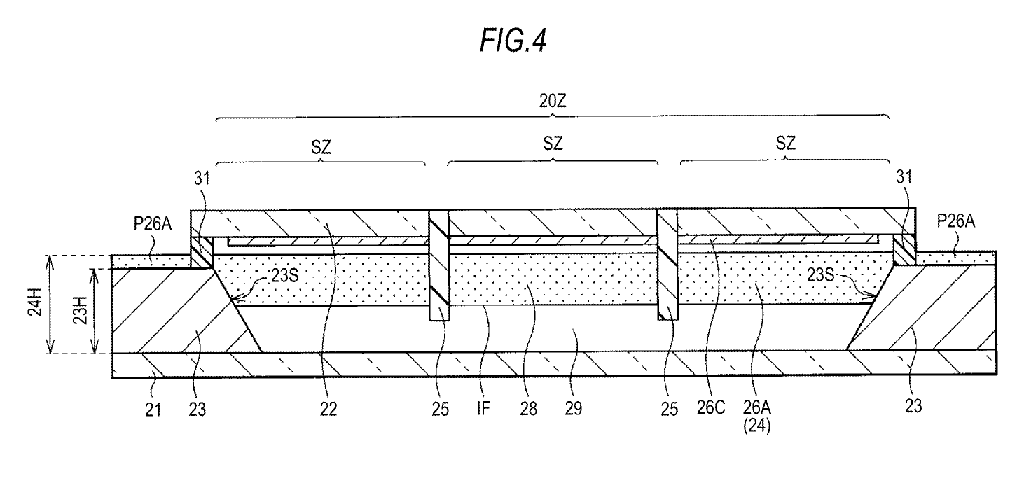

FIG. 2 is an enlarged cross-sectional view illustrating a main part of the wavefront conversion deflecting section 2 parallel to an XY plane perpendicular to the traveling direction of the display image light. Further, FIGS. 3A and 3B are cross-sectional views seen in arrow directions, taken along lines III(A)-III(A) and III(B)-III(B) in FIG. 2. Further, FIG. 4 is a cross-sectional view seen in an arrow direction, taken along line IV-IV in FIG. 2. FIG. 2 corresponds to a cross-section seen in an arrow direction, taken along line II-II in FIGS. 3A and 3B.

As shown in FIG. 2, FIGS. 3A and 3B and FIG. 4, the wavefront conversion deflecting section 2 includes a pair of planar substrates 21 and 22 which are disposed opposite to each other, and side walls 23 and partition walls 24 which are provided upright in an inner surface 21S of the planar substrate 21 opposite to the planar substrate 22 and support the planar substrate 22 through an adhesive layer 31. In the wavefront conversion deflecting section 2, the plurality of liquid optical devices 20 which are partitioned by the plurality of partition walls 24 which extend in the Y axis direction are aligned in the X axis direction, and form an optical device as a whole. The liquid optical devices 20 include two types of liquids having different refraction index (polarity liquid 28 and non-polarity liquid 29), and performs an optical function such as deflection or refraction for incident light.

The planar substrates 21 and 22 are formed of a transparent insulation material which transmits visible light, such as glass or transparent plastic. On the inner surface 21S of the planar substrate 21, the plurality of partition walls 24 which divide a space region on the planar substrate 21 into a plurality of cell regions 20Z are disposed. The plurality of partition walls 24 respectively extend in the Y axis direction as described above, and form the plurality of cell regions 20Z having a rectangular planar shape corresponding to the group of pixels 12 which extends in the Y axis direction, in cooperation with the plurality of side walls 23. That is, the side walls 23 connect ends of the plurality of partition walls 24 and connect the other ends thereof, to surround the plurality of cell regions 20Z in cooperation with the side walls 24. When the inner surface 21S of the planar substrate 21 is used as a reference position, it is preferable that a height 23H of the side wall 23 be lower than a height 24H of the side wall 24 (see FIG. 4). The non-polarity liquid 29 is retained in each cell region 20Z partitioned by the side walls 24. That is, the non-polarity liquid 29 does not move (flow) to another adjacent cell region 20Z due to the presence of the partition wall 24. The partition wall 24 is preferably formed of material which is not dissolved in the polarity liquid 28 and the non-polarity liquid 29, such as epoxy resin, acryl resin or the like. The planar substrate 21 and the partition walls 24 may be formed of the same transparent plastic material, or may be integrally formed.

First and second electrodes 26A and 26B which are opposite to each other are formed on wall surfaces of each partition wall 24. As material which forms the first and second electrodes 26A and 26B, a transparent conductive material such as Indium Tin Oxide (ITO) or Zinc Oxide (ZnO), a metallic material such as copper (Cu), or other conductive materials such as carbon (C) or conductive polymers may be used. The first and second electrodes 26A and 26B continuously extend from one end of the partition wall 24 to the other end thereof without pause, and are commonly formed over a plurality of sub cell regions SZ (which will be described later) in one cell region 20Z. Each of the first and second electrodes 26A and 26B is connected to an external power source (not shown) through a signal line formed on the planar substrate 21 and a control section. Each of the first and second electrodes 26A and 26B may be set to have an electric potential of a predetermined magnitude by the control section. Both ends of each of the first and second electrodes 26A and 26B are connected to a pair of pads P26A or a pair of pads P26B which are formed on an upper surface of the side wall 23. Here, as shown in FIG. 4, if the height of the side wall 23 is lower than the height of the partition wall 24, since a step does not occur in a connecting section between the first and second electrodes 26A and 26B and the pads P26A and P26B, it is possible to easily prevent disconnection or increase in connection resistance in the connecting section due to variation of manufacturing conditions or the like. In order to prevent the disconnection or increase in connection resistance in the connecting section, an edge surface 23S (edge surface 23S facing the cell region 20Z) inside the side wall 23 is preferably inclined. Further, it is preferable that the first and second electrodes 26A and 26B be tightly covered by a hydrophobic insulation film 27. The hydrophobic insulation film 27 represents a hydrophobic property (water-repellency) for the polarity liquid 28 (strictly speaking, represents affinity for the non-polarity liquid 29 under a non-electric field), and is formed of material having an excellent electrical insulation property. Specifically, polyvinylidene fluoride (PVdF) or polytetrafluoroethylene (PTFE) which is fluorinated polymer, silicon, or the like may be used, for example. Here, in order to further enhance the electrical insulation property between the first electrode 26A and the second electrode 26B, a different insulation film formed of a spin-on-glass (SOG) or the like, for example, may be formed between the first and second electrodes 26A, 26B and the hydrophobic insulation film 27. An upper end of the partition wall 24 or the hydrophobic insulation film 27 which covers the upper end is preferably separated from the planar substrate 22 and a third electrode 26C. In FIG. 4, the hydrophobic insulation film 27 is omitted in illustration.

One or two or more protruding sections 25 are formed upright on the planar substrate 22 in each cell region 20Z. The protruding section 25 divides each cell region 20Z into a plurality of sub cell regions SZ which are arranged in the Y axis direction. In a case where the protruding section 25 is plurally provided, the plurality of protruding sections 25 may be arranged at uniform intervals along the Y axis direction. The protruding section 25 is arranged so that both end surfaces 25T thereof in the X axis direction are in contact with the hydrophobic insulation film 27 which covers the side wall 24 and the first and second electrodes 26A and 26B (so that both the end surfaces 25T are in contact with the first and second electrodes 26A and 26B in a case where the hydrophobic insulation film 27 is not present). FIGS. 2 and 4 illustrate a case where the plurality of protruding sections 25 are arranged along the Y axis direction, but the number thereof may be arbitrarily selected.

The protruding section 25 is preferably formed of an elastic body having hardness lower than those of the partition wall 24, the hydrophobic insulation film 27, and the first and second electrodes 26A and 26B, for example. As such an elastic body, for example, polyurethane, silicon, polyamide, or different thermoplastic elastomer may be used. The configuration that the protruding section 25 is formed of such an elastic body functions to prevent damage of the first and second electrodes 26A and 26B, or the hydrophobic insulation film 27 which covers the first and second electrodes 26A and 26B when a lower structure in which the partition walls 24, the first and second electrodes 26A and 26B, the hydrophobic insulation films 27 and the like are formed on the planar substrate 21 is coupled with an upper structure in which the third electrodes 26C and the protruding sections 25 are formed on the planar substrate 22 in a manufacturing process. For the same purpose, the protruding section 25 may be obtained by forming a film of material having hardness lower than the partition wall 24, the hydrophobic insulation film 27 and the first and second electrodes 26A and 26B on a surface of a substrate formed of the same material as the partition wall 24, for example. As the material which forms such a film, for example, PTFE (polytetrafluoroethylene), silicon or the like may be preferably used.

The third electrode 26C is formed on an inner surface 22S of the planar substrate 22 which is opposite to the planar substrate 21. The third electrode 26C is formed of a transparent conductive material such as ITO or ZnO, and functions as a ground electrode.

The polarity liquid 28 and the non-polarity liquid 29 are sealed in a space region completely closed by the pair of planar substrates 21 and 22, and the side walls 23 and the partition walls 24. The polarity liquid 28 and the non-polarity liquid 29 are separated from each other without being dissolved in the closed space, to thereby form an interface IF.

The non-polarity liquid 29 barely has polarity, and has a liquid material indicating an electric insulation property. For example, silicon oil or the like in addition to a hydrocarbon series material such as decane, dodecane, hexadecane or undecane are preferably used as the non-polarity liquid 29. The non-polarity liquid 29 preferably has a sufficient capacity to cover the entire surface of the planar substrate 21 in a case where voltage is not applied between the first electrode 26A and the second electrode 26B.

On the other hand, the polarity liquid 28 is a liquid material having polarity. For example, water or water solution which is obtained by dissolving electrolyte such as potassium chloride or sodium chloride is preferably used as the polarity liquid 28. If voltage is applied to the polarity liquid 28, a wetting property for the inner surfaces 27A and 27B (contact angle between the polarity liquid 28 and the inner surfaces 27A and 27B) is significantly changed compared with the non-polarity liquid 29. The polarity liquid 28 is in contact with the third electrode 26C which is the ground electrode.

The polarity liquid 28 and the non-polarity liquid 29 are adjusted to have approximately the same specific gravity at room temperature (for example, 20° C.), and the positional relationship between the polarity liquid 28 and the non-polarity liquid 29 are determined in the sealing order. Since the polarity liquid 28 and the non-polarity liquid 29 are transparent, light which transmits the interface IF is refracted according to an incident angle of the light and the refraction index of the polarity liquid 28 and the non-polarity liquid 29.

The polarity liquid 28 and the non-polarity liquid 29 are stably retained in an initial position (shown in FIGS. 3A and 3B) by the presence of the protruding section 25. This is because the polarity liquid 28 and the non-polarity liquid 29 are in contact with the protruding section 25 so that interface tension is exerted in the contact interface. In particular, an interval L1 (see FIG. 2) of the protruding sections 25 disposed in the same cell region 20Z may be equal to or shorter than a capillary length K⁻¹ expressed as the following conditional expression (1). The capillary length K⁻¹ refers to the maximum length in which the influence of gravity can be ignored for the interface tension occurring in an interface between the polarity liquid 28 and the non-polarity liquid 29. Accordingly, when the interval L1 satisfies the conditional expression (1), the polarity liquid 28 and the non-polarity liquid 29 are sufficiently stably retained in the initial position (shown in FIGS. 3A and 3B) without being influenced by the posture of the wavefront converting section 2 (and deflecting section 3).

K⁻¹={Δγ/(Δρ×g)}^{0.5} (1)
where is a capillary length (mm);
Δγ is interface tension between a polarity liquid and a non-polarity liquid (mN/m);
Δρ is density difference between a polarity liquid and a non-polarity liquid (g/cm³); and
g is the acceleration of gravity (m/s²).

Further, in this embodiment, for the same reason as described above, the protruding sections 25 positioned in both ends in the Y axis direction among the plurality of protruding sections 25 are preferably disposed so that the shortest distance L2 (see FIG. 2) from the side wall 23 in the Y axis direction is equal to or shorter than the capillary length K⁻¹ expressed as the above conditional expression (1).

As described above, the capillary length K⁻¹ is changed according to the types of two mediums which form the interface. For example, if the polarity liquid 28 is water and the non-polarity liquid 29 is oil, since the interface tension Δγ of the conditional expression (1) is 29.5 mN/m and the density difference Δρ is 0.129 g/cm³, the capillary length K⁻¹ is 15.2 mm. Accordingly, by setting the density difference Δρ to 0.129 g/cm³ or less, it is possible to set the interval L1 and the distance L2 to a maximum of 15.2 mm.

In the liquid optical device 20, in a state where voltage is not applied between the first and second electrodes 26A and 26B (in a state where electric potentials of the electrodes 26A and 26B are all zero), as shown in FIG. 3A, the interface IF forms a convex curve toward the non-polarity liquid 29 from the side of the polarity liquid 28. Here, the curvature of the interface IF is uniform in the Y axis direction, and each liquid optical device 20 functions as one cylindrical lens. Further, the curvature of the interface IF becomes the maximum in this state (in a state where voltage is not applied between the first and second electrodes 26A and 26B). A contact angle θ1 of the non-polarity liquid 29 for the inner surface 27A and a contact angle θ2 of the non-polarity liquid 29 for the inner surface 27B can be adjusted by selecting the type of material of the hydrophobic insulation film 27, for example. Here, if the non-polarity liquid 29 has a refraction index larger than the polarity liquid 28, the liquid optical device 20 provides a negative refraction force. On the other hand, if the non-polarity liquid 29 has a refraction index smaller than the polarity liquid 28, the liquid optical device 20 provides a positive refraction force. For example, if the non-polarity liquid 29 is hydrocarbon system material or silicon oil and the polarity liquid 28 is water or electrolytic water solution, the liquid optical device 20 provides a negative refraction force.

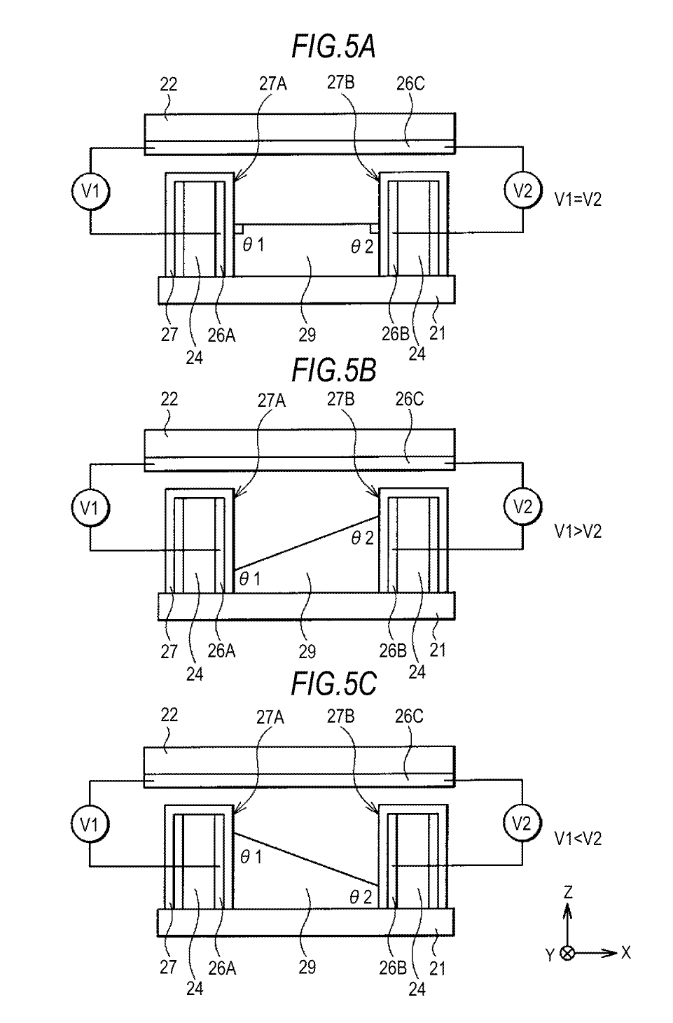

If voltage is applied between the first and second electrodes 26A and 26B, the curvature of the interface IF becomes small, and if voltage of a certain level or higher is applied, for example, the interface IF becomes a plane as shown in FIGS. 5A to 5C. FIG. 5A illustrates a case where an electric potential (V1) of the first electrode 26A and an electric potential (V2) of the second electrode 26B are the same (V1=V2). In this case, both the contact angles θ1 and θ2 become a right angle (90° C.). At this time, incident light which enters the liquid optical device 20 and passes through the interface IF is output from the liquid optical device 20 as it is, without an optical effect such as convergence, divergence or deflection in the interface IF.

In a case where the electric potential V1 and the electric potential V2 are different from each other (V1≠V2), for example, as shown in FIGS. 5B and 5C, the interface IF becomes a plane (parallel to the Y axis) inclined with respect to the X axis and Z axis (θ1≠θ2). Specifically, if the electric potential V1 is larger than the electric potential V2 (V1>V2), as shown in FIG. 5B, the contact angle θ1 is larger than the contact angle θ2 (θ1>θ2). On the other hand, if the electric potential V2 is larger than the electric potential V1 (V1<2), as shown in FIG. 5C, the contact angle θ2 is larger than the contact angle θ1 (θ1<θ2). In these cases (V1≠V2), for example, the incident light which travels in parallel with the first and second electrodes 26A and 26B to enter the liquid optical device 20 is refracted in the XZ plane in the interface IF to be then deflected. Accordingly, by adjusting the magnitudes of the electric potential V1 and the electric potential V2, it is possible to deflect the incident light in a predetermined direction in the XZ plane.

It is inferred that such a phenomenon (change in the contact angles θ1 and θ2 according to application of voltage) occurs as follows. That is, electric charge is accumulated in the inner surfaces 27A and 27B by application of voltage, and the polarity liquid 28 having polarity is pulled to the hydrophobic insulation film 27 by a coulomb force of the electric charges Then, an area of the polarity liquid 28 which is in contact with the inner surfaces 27A and 27B is enlarged, and the non-polarity liquid 29 moves (deforms) to be retreated by the polarity liquid 28 from a portion of being in contact with the inner surfaces 27A and 27B. As a result, the interface IF comes close to the plane.

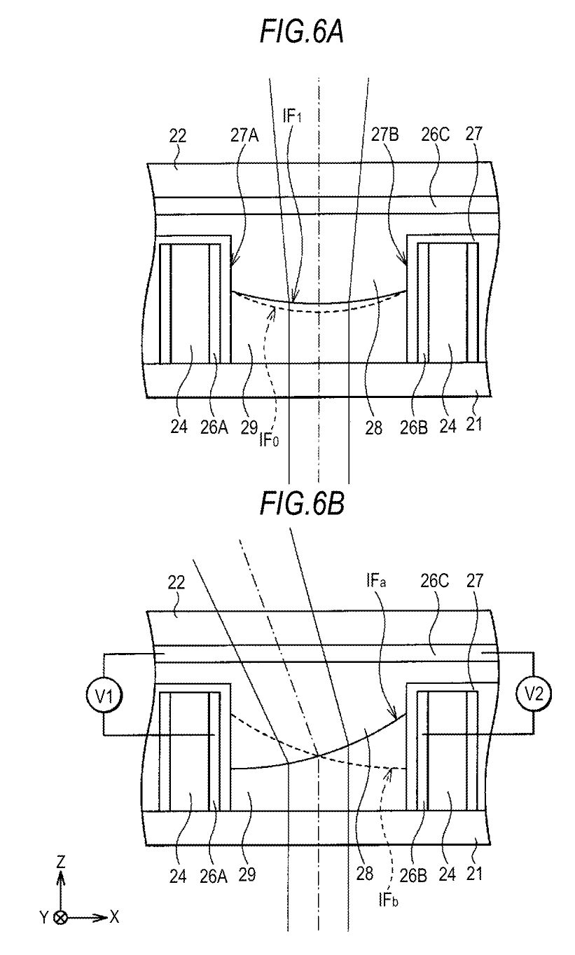

Further, the curvature of the interface IF is changed by adjustment of the magnitudes of the electric potential V1 and the electric potential V2. For example, if the electric potentials V1 and V2 (V1=V2) are a value lower than an electric potential Vmax when the interface IF becomes a horizontal plane, for example, as shown in FIG. 6A, an interface IF₁ (indicated by a solid line) having a curvature, which is smaller than that of an interface IF₀ (indicated by a broken line) in a case where the electric potentials V1 and V2 are zero, is obtained. Thus, it is possible to adjust a refraction force exerted on light which passes through the interface IF by changing the magnitudes of the electric potential V1 and the electric potential V2. That is, the liquid optical device 20 functions as a variable-focus lens. Further, if the electric potential V1 and the electric potential V2 have different magnitudes in this state (V1≠V2), the interface IF is in an inclined state, while having an appropriate curvature. For example, if the electric potential V1 is larger than the electric potential V2 (V1>V2), an interface IFa is formed as indicated by a solid line in FIG. 6B. On the other hand, if the electric potential V2 is larger than the electric potential V1 (V1<V2), an interface IFb is formed as indicated by a broken line in FIG. 6B. Accordingly, by adjusting the magnitudes of the electric potential V1 and the electric potential V2, the liquid optical device 20 can provide the appropriate refraction force for incident light and can deflect the incident light in a predetermined direction. In FIGS. 6A and 6B, in a case where the non-polarity liquid 29 has a refraction index larger than that of the polarity liquid 28 and the liquid optical device 20 provides a negative refraction force, changes in incident light when the interfaces IF₁ and IFa are formed are shown.

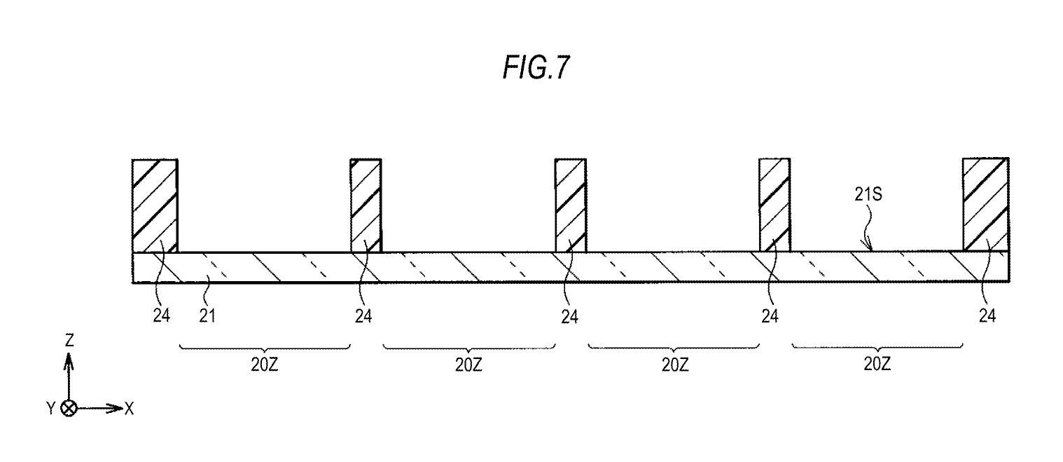

Next, a manufacturing method of the wavefront conversion deflecting section 2 will be described with reference to schematic cross-sectional diagrams shown in FIGS. 7 to 9.

Firstly, the planar substrate 21 is prepared, and then, as shown in FIG. 7, the side walls 23 (not shown in FIG. 7) and the partition walls 24 are respectively formed in predetermined positions on one surface thereof (inner surface 21 S). Specifically, for example, a predetermined resin is coated on the inner surface 21S with a thickness as uniform as possible by a spin coating method, and then the resin coating is selectively exposed by a photolithography method to thereby perform patterning. Alternatively, the planar substrate 21, the side walls 23 and the partition walls 24 which are integrally formed of the same type of material may be formed by batch molding using a mold of a predetermined shape. Further, these may be formed by injection molding, thermal press forming, transfer forming using a film material, 2P (photoreplication process), or the like.

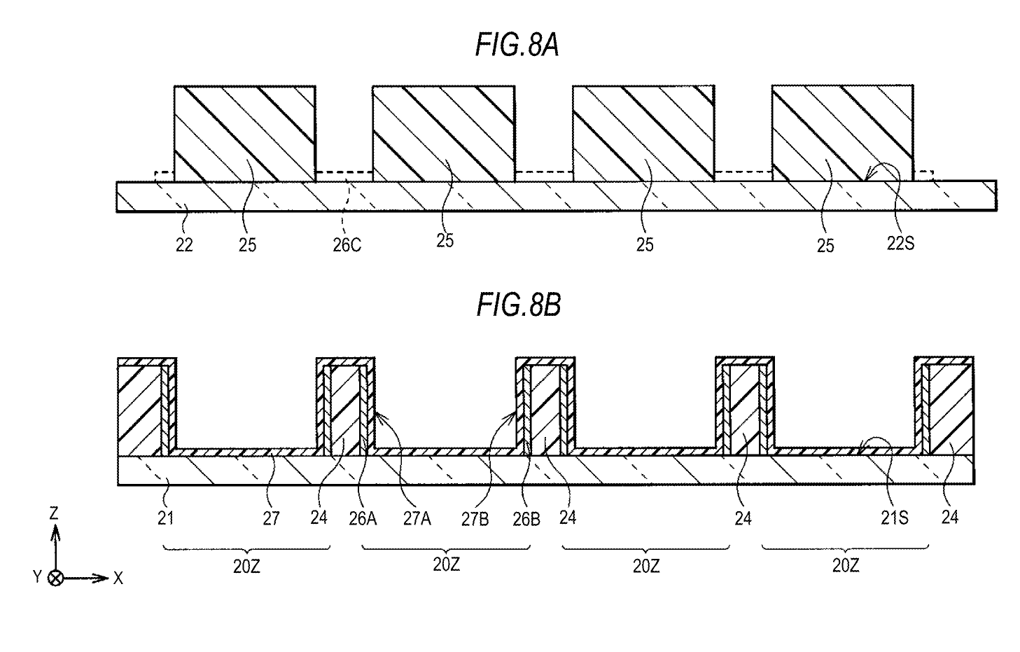

Next, the planar substrate 22 is prepared, and then, as shown in FIG. 8A, the protruding sections 25 are formed in predetermined positions on one surface (inner surface 22S) thereof. The protruding sections 25 can be formed in a similar way to the side walls 23 and the partition walls 24. Thereafter, the third electrodes 26C formed of a predetermined conductive material are formed on the inner surface 22S. In order to form the third electrode 26C, for example, a technique such as photolithography, mask transfer or inkjet drawing can be used. Thus, the upper structure is completed.

On the other hand, on the end surfaces of the partition wall 24 formed on the planar surface 21, as shown in FIG. 8B, the first and second electrodes 26A and 26B formed of a predetermined conductive material are formed by the same method as in the third electrode 26C, for example. Further, as necessary, the hydrophobic insulation film 27 formed of paraxylene resin, fluorinated resin, inorganic insulation material or the like is formed to cover at least the first and second electrodes 26A and 26B. When the paraxylene resin is used, the hydrophobic insulation film 27 may be formed by a deposition method; when the fluorinated resin is used, the hydrophobic insulation film 27 may be formed by a sputtering method or a dip-coating method; and when the inorganic insulation material is used, the hydrophobic insulation film 27 may be formed by a sputtering method or a CVD method. The hydrophobic insulation film 27 may cover the inner surface 21S or the protruding section 25. Thus, the lower structure is completed.

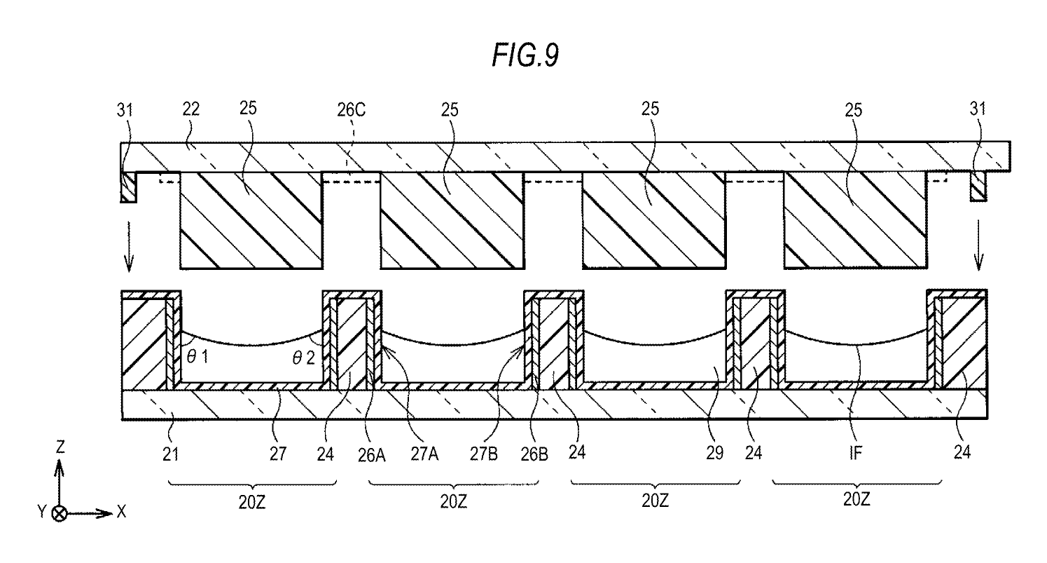

Subsequently, as shown in FIG. 9, the non-polarity liquid 29 is injected or dropped to the respective cell regions 20Z partitioned by the partition walls 24. Thereafter, the upper structure shown in FIG. 8A and the lower structure shown in FIG. 8B are coupled so that the inner surface 22S and the inner surface 21S face each other. At this time, the adhesion layer 31 is formed to surround the plurality of cell regions 20Z along an outer edge of a region where the planar substrate 21 and the planar substrate 22 are overlapped, and thus, the planar substrate 22 is fixed to the side walls 23 and the partition walls 24 through the adhesion layer 31. An injection port (not shown) is formed in a part of the adhesion layer 31. Finally, the polarity liquid 28 is filled in a space surrounded by the planar substrate 21, the side walls 23, the partition walls 24 and the planar substrate 22, and then the injection port is sealed. According to the above-mentioned procedure, it is possible to simply manufacture the wavefront conversion deflecting section 2 which includes the liquid optical device 20 with an excellent response property.

### <Operation of Stereoscopic Display Apparatus>

In the stereoscopic display apparatus, if a video signal is input to the display section 1, a left eye display image light IL is emitted from the pixel 12L, and a right eye display image light IR is emitted from the pixel 12R. The display image lights IL and IR all enter the liquid optical device 20. In the liquid optical device 20, voltage of an appropriate value is applied to the first and second electrodes 26A and 26B so that its focal distance becomes a distance obtained by air-exchanging the refraction index between the pixels 12L and 12R and the interface IF, for example. According to a position of an observer, the focal distance of the liquid optical device 20 may be changed forward or backward. According to the operation of the cylindrical lens formed by the interface IF between the polarity liquid 28 and the non-polarity liquid 29 in the liquid optical device 20, emission angles of the display image lights IL and IR emitted from the respective pixels 12L and 12R of the display section 1 are selected. Thus, as shown in FIG. 1, the display image light IL enters a left eye 10L of the observer, and the display image light IR enters a right eye 10R of the observer. Thus, the observer can observe a stereoscopic video.

Further, as the interface IF in the liquid optical device 20 is adjusted as the flat plane (see FIG. 5A) and the wavefront conversion for the display image lights IL and IR is not performed, it is possible to display a two dimensional image with high definition.

### <Effects of Present Embodiment>

In this way, in the wavefront conversion deflecting section 2 according to this embodiment, the protruding section 25 is formed on the planar substrate 22 to divide each cell region 20Z partitioned by the partition wall 24 into the plurality of sub cell regions SZ. Thus, even when the frontwave conversion deflecting section 2 (liquid optical device 20) is disposed so that the cell region 20Z extends in the vertical direction, two types of liquids (the polarity liquid 28 and the non-polarity liquid 29) having different refractive indexes and specific gravities are stably retained in the peripheral members such as the protruding section 25 and the partition wall 24 by the capillary phenomenon. That is, it is possible to stably maintain the interface IF over a long period of time and to stably provide a desired optical operation, without being influenced by gravity due to the posture of the liquid optical device 20. Thus, according to the stereoscopic display apparatus including the liquid optical device 20, it is possible to realize a correct image display corresponding to a predetermined video signal over a long period of time.

Further, in the present embodiment, since the partition wall 24 is formed on the planar substrate 21 and the protruding section 25 is formed on the planar substrate 22, it is possible to realize accurate and efficient manufacturing. For example, since the planar substrate 21 on which the partition wall 24 is formed has a uniform cross-sectional shape in the Y axis direction along which the partition wall 24 extends, it is possible to form these elements in a batch by uniaxial molding using the same material. As the uniaxial molding, for example, extrusion molding or laminated transfer using a molding roll may be used. By employing the above-mentioned uniaxial molding, it is possible to easily provide a partition wall having a shape of high accuracy. In this case, in order to connect one side ends of the partition walls 24 to each other and to connect the other side ends thereof to each other, it is necessary to form the side walls 23 by a different process.

Further, compared with a case where both the partition walls 24 and the protruding sections 25 are formed on one substrate (planar substrate 21), it is possible to reduce variation in the thicknesses of the first and second electrodes 26A and 26B. Further, when the wavefront conversion deflecting section 2 which is the optical device is assembled, by coupling the partition walls 24 formed on the planar substrate 21 and the protruding sections 25 formed on the planar substrate 22, the planar substrate 21 and the planar substrate 22 can be relatively easily positioned. Particularly, in the present embodiment, the width of the protruding section 25 in the X axis direction coincides with the width of the cell region 20Z, and the both end surfaces 25T of the protruding section 25 are respectively in contact with the hydrophobic insulation film 27 which covers the first and second electrodes 26A and 26B. Thus, it is possible to more easily and simply perform the positioning between the planar substrate 21 and the planar substrate 22. Further, for example, in a case where the planar substrates 21 and 22 are formed of glass and the partition wall 24 is formed of resin, expansion and contraction of the partition wall 24 due to heat can be alleviated by the presence of the protruding section 25 which is in contact with the hydrophobic insulation film 27 which covers the partition wall 24.

On the other hand, the protruding section 25 formed on the planar substrate 22 is separated from the planar substrate 21 covered by the hydrophobic insulation film 27, and the planar substrate 22 is separated from the partition wall 24 covered by the hydrophobic insulation film 27. Thus, when the polarity liquid 28 and the non-polarity liquid 29 are injected to the cell region 20Z in the manufacturing process, the polarity liquid 28 and the non-polarity liquid 29 circulates in a gap between the protruding section 25 and the hydrophobic insulation film 27 which covers the planar substrate 21, and a gap between the planar substrate 22 and the hydrophobic insulation film 27 which covers the partition wall 24. As a result, in the same cell region 20Z, the ratio of the polarity liquid 28 and the non-polarity liquid 29 is uniformized to prevent variation in the position of the interface IF. Accordingly, it is possible to assign a stable optical operation to the display image lights IL (or IR) from the plurality of pixels 12L (or 12R) arranged in the Y axis direction.

Further, in the present embodiment, the protruding section 25 is formed of an elastic body which is lower in hardness than the partition wall 24, the hydrophobic insulation film 27, and the first and second electrodes 26A and 26B. Alternatively, the protruding section 25 is provided with a film of PTFE, silicon or the like formed on a surface of a substrate having the same hardness as that of the partition wall 24, for example. Thus, in the manufacturing process, it is possible to prevent damage to the first and second electrodes 26A and 26B and the hydrophobic insulation film 27.

Further, in the present embodiment, the first and second electrodes 26A and 26B which are disposed so as to be opposite to each other on the wall surfaces of the partition wall 24 continuously extend from one end of the partition wall 24 to the other end thereof without any pause, the following operation is obtained during running That is, if voltage is applied between the first and second electrodes 26A and 26B in a certain cell region 20Z, liquid surfaces of the polarity liquid 28 and the non-polarity liquid 29 in the plurality of sub cell regions SZ which form the same cell region 20Z show more correct behavior collectively. In particular, if the height 23H of the side wall 23 is lower than the height 24H of the partition wall 24, since a step does not occur in a connecting section between the first and second electrodes 26A and 26B, and the pads P26A and P26B, it is possible to secure a constant cross-sectional area in the connecting section, to thereby easily prevent increase in resistance in one pair of pads P26A and in one pair of pads P26B.

### <First Modification>

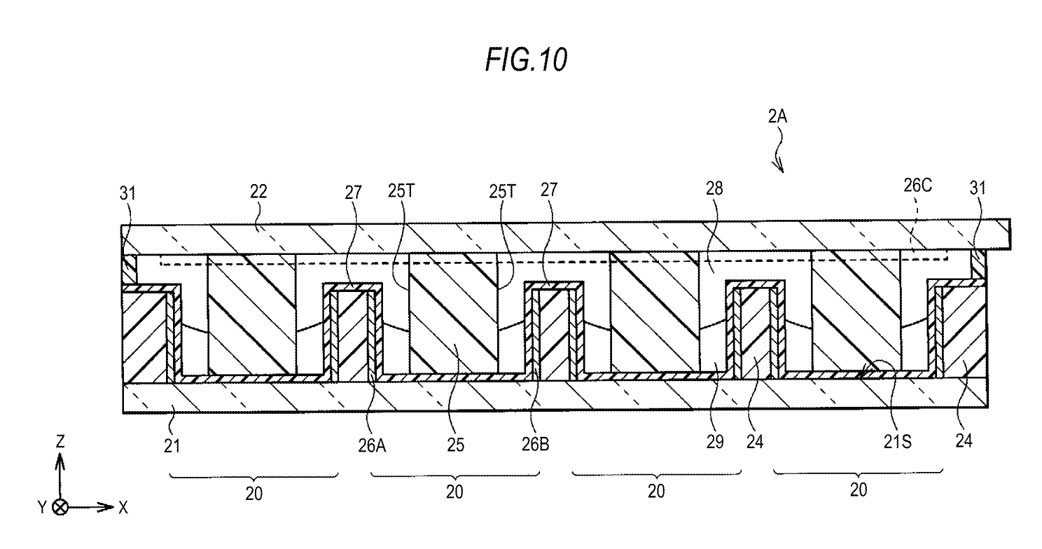

FIG. 10 illustrates a wavefront conversion deflecting section 2A which is a first modification according to the present embodiment, which shows a cross-sectional configuration of the wavefront conversion deflecting section 2A and corresponds to FIG. 3B in the above-described embodiment. In the above-described embodiment, the end surfaces 25T of the protruding section 25 are in contact with portions of the hydrophobic insulation film 27, which cover the partition wall 24. On the other hand, in the present modification, the protruding section 25 is separated from a portion of the hydrophobic insulation film 27 which covers the partition wall 24 and is in contact with a portion of the hydrophobic insulation film 27 which covers the planar substrate 21. With this configuration, even when the protruding section 25 is formed of material with relatively high hardness, it is possible to prevent damage of the portion of the hydrophobic insulation film 27 which covers the partition wall 24, and to more accurately maintain the gap between the planar substrate 21 and the planar substrate 22.

### <Second Modification>

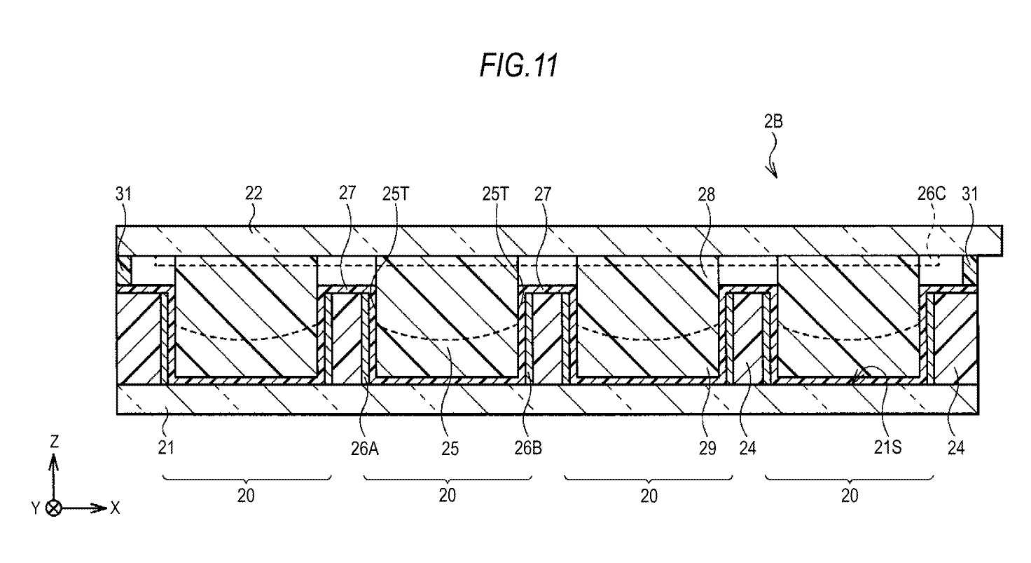

FIG. 11 illustrates a wavefront conversion deflecting section 2B which is a second modification according to the present embodiment, which shows a cross-sectional configuration of the wavefront conversion deflecting section 2B and corresponds to FIG. 3B in the above-described embodiment. In the above-described embodiment, the protruding section 25 is separated from the portion of the hydrophobic insulation film 27 which covers the planar substrate 21. On the other hand, in the present modification, the protruding section 25 is in contact with the portion of the hydrophobic insulation film 27 which covers the planar substrate 21. With this configuration, it is possible to more accurately maintain the gap between the planar substrate 21 and the planar substrate 22.

### <Third Modification>

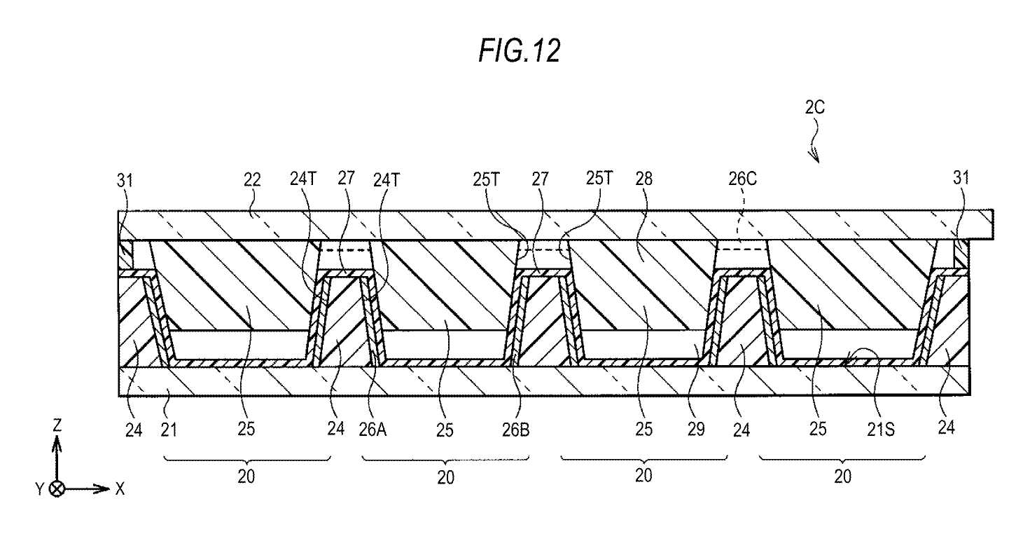

FIG. 12 illustrates a wavefront conversion deflecting section 2C which is a third modification according to the present embodiment, which shows a cross-sectional configuration of the wavefront conversion deflecting section 2C and corresponds to FIG. 3B in the above-described embodiment. In the above-described embodiment, the end surfaces 25T of the protruding section 25 are formed to be perpendicular to the inner surface 22S. On the other hand, in the present modification, both end surfaces 25T of the protruding section 25 are inclined to become gradually close to each other as they move away from the planar substrate 22. With this configuration, it is possible to more simply perform the positioning between the planar substrate 21 and the planar substrate 22, when the wavefront conversion deflecting section 2 is assembled. In this case, as shown in FIG. 12, the width of the partition wall 24 in the X axis direction is gradually narrowed as they move away from the planar surface 21. With this configuration, compared with a case where the wall surfaces of the partition wall 24 are perpendicular to the inner surface 21S, when the first and second electrodes 26A and 26B are formed on the wall surfaces of the partition wall 24, it is possible to easily control the thicknesses thereof. As a result, it is possible to prevent resistance increase of the first and second electrodes 26A and 26B. In particular, this is effective in a case where the deposition method is used. Further, in the present modification, by bringing the protruding section 25 in contact with the portion of the hydrophobic insulation film 27 which covers the planar substrate 21, it is possible to more accurately maintain the gap between the planar substrate 21 and the planar substrate 22.

Hereinbefore, the embodiments of the present disclosure have been described, but the present disclosure is not limited to the above-described embodiments, and a variety of different modifications is available. For example, in the above-described embodiments, the light focusing or diverging effect and the deflection effect are all provided by the liquid optical device 20 in the wavefront conversion deflecting section 2. However, by individually forming the wavefront converting section and the deflecting section, the light focusing or diverging effect and the deflection effect may be assigned to the display image light by the individual devices.

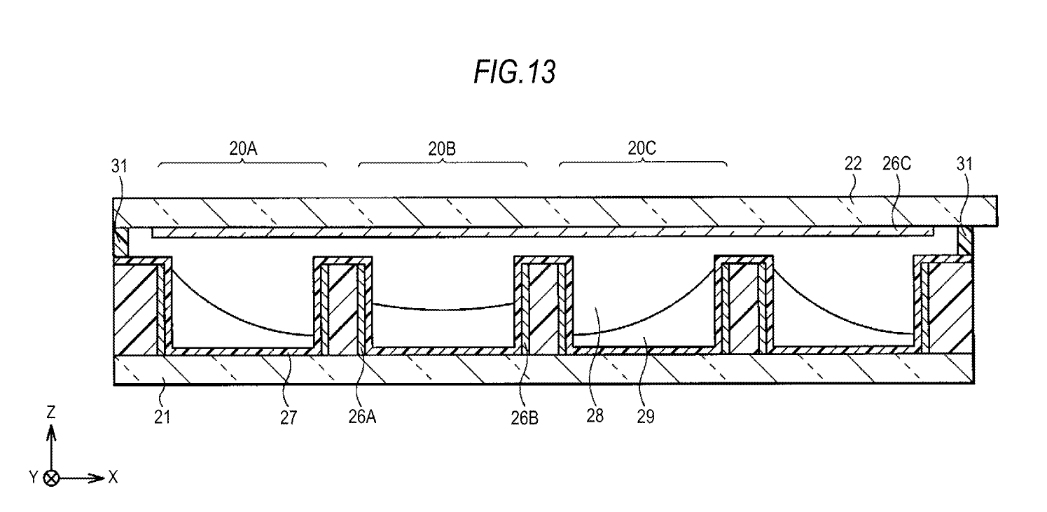

Further, as shown in FIG. 13, by matching one set of pixels 12L and 12R with the plurality of liquid optical devices 20 and by combining the plurality of liquid optical devices 20, the function of one cylindrical lens may be obtained. FIG. 13 shows an example in which one cylindrical lens is formed by the liquid optical devices 20A, 20B and 20C.

Further, in the above-described embodiments, the third electrodes 26C extend on the inner surface 22S of the planar substrate 22 in order to correspond to approximately all the plurality of sub cell regions SZ. However, as long as a state where the third electrodes 26C are in any contact with the polarity liquid 28 is constantly maintained, its size (formation area) may be arbitrarily selected.

Further, in the above-described embodiments, the planar shape of each cell region is rectangular, but the present disclosure is not limited thereto. For example, a parallelogram shape may be used. Further, in the above-described embodiments, the protruding section extends in the direction (X axis direction) perpendicular to the extension direction (Y axis direction) of the partition wall, but the present disclosure is not limited thereto. That is, the protruding section may extend in a different direction. Further, the shape of the protruding section is not limited to the shape shown in the drawings, and may be a different shape.

Further, in the above-described embodiments, a color liquid crystal display employing a backlight is used as two dimensional image generating means, but the present disclosure is not limited thereto. For example, a display employing an organic EL or a plasma display may be used.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An optical device comprising:
a first substrate and a second substrate which are disposed being opposite to each other;
a partition wall which is provided upright on an inner surface of the first substrate, which faces the second substrate, and extends, to divide a region on the first substrate into a plurality of cell regions which are arranged in a first direction, in a second direction which is different from the first direction;
a first electrode and a second electrode which are disposed on wall surfaces of the partition wall to face each other in each of the plurality of cell regions;
an insulation film which covers the first and second electrodes;
a third electrode which is provided on an inner surface of the second substrate which faces the first substrate;
a protruding section which is formed upright on the inner surface of the second substrate and divides each of the plurality of cell regions into a plurality of sub cell regions which are arranged in the second direction; and
a polarity liquid and a non-polarity liquid which are sealed between the first substrate and the third electrode and have different refractive indexes.

2. The optical device according to claim 1,
wherein the protruding section includes an elastic body which is lower in hardness than the partition wall, the insulation film, and the first and second electrodes.

3. The optical device according to claim 2,
wherein both edge surfaces of the protruding section in the first direction are in contact with the insulation films.

4. The optical device according to claim 3,
wherein the protruding section is in contact with the first substrate.

5. The optical device according to claim 1,
wherein both edge surfaces of the protruding section in the first direction are inclined to become gradually close to each other as the edge surfaces move away from the second substrate.

6. The optical device according to claim 5,
wherein the protruding section is in contact with the first substrate.

7. The optical device according to claim 1,
wherein the protruding section is formed of thermoplastic elastomer.

8. The optical device according to claim 1,
wherein the insulation film is formed of polytetrafluoroethylene (PTFE) or silicon.

9. An optical device comprising:
a first substrate and a second substrate which are disposed being opposite to each other;
a partition wall which is provided upright on an inner surface of the first substrate which faces the second substrate and is arranged in a first direction;
a protruding section which is provided upright on an inner surface of the second substrate which faces the first substrate and is arranged in a second direction which different from the first direction;
a first electrode and a second electrode which are provided on surfaces of the partition wall to be opposite to each other; and
a first liquid and a second liquid which are sealed between the first substrate and the second substrate and have different refractive indexes.

10. The optical device according to claim 9,
wherein the protruding section includes an elastic body which is lower in hardness than the partition wall.

11. The optical device according to claim 9,
wherein both edge surfaces of the protruding section in the first direction are in contact with an insulation film.

12. The optical device according to claim 9,
wherein the protruding section is in contact with the first substrate.

13. The optical device according to claim 9,
wherein both edge surfaces of the protruding section in the first direction are inclined to become gradually close to each other as the edge surfaces move away from the second substrate.

14. The optical device according to claim 13,
wherein the protruding section is in contact with the first substrate.

15. The optical device according to claim 9,
wherein the protruding section is formed of thermoplastic elastomer.

16. The optical device according to claim 9, further comprising an insulation film which covers the first and second electrodes,
wherein the insulation film is formed of polytetrafluoroethylene (PTFE) or silicon.

17. A stereoscopic display apparatus comprising display means and an optical device,
the optical device including:
a first substrate and a second substrate which are disposed being opposite to each other;
a partition wall which is provided upright on an inner surface of the first substrate, which faces the second substrate, and extends, to divide a region on the first substrate into a plurality of cell regions which are arranged in a first direction, in a second direction which is different from the first direction;
a first electrode and a second electrode which are disposed on wall surfaces of the partition wall to face each other in each of the plurality of cell regions;
an insulation film which covers the first and second electrodes;
a third electrode which is provided on an inner surface of the second substrate which faces the first substrate;
a protruding section which is formed upright on the inner surface of the second substrate and divides each of the plurality of cell regions into a plurality of sub cell regions which are arranged in the second direction; and
a polarity liquid and a non-polarity liquid which are sealed between the first substrate and the third electrode and have different refractive indexes.

18. The stereoscopic display apparatus according to claim 17,
wherein the optical device has a function of deflecting display image light from the display means in the first direction.

19. The stereoscopic display apparatus according to claim 18,
wherein the optical device functions as wavefront converting means for converting the curvature of wavefronts in the display image light from the display means.
